(19) United States
(12) Patent Application Publication
(10) Pub. No.: US 2026/0245217 A1
(43) Pub. Date: Aug. 20, 2026

(54) NON-TRANSITORY COMPUTER READABLE MEDIUM AND POSITION ESTIMATION APPARATUS

(71) Applicant: Honda Motor Co., Ltd., Tokyo (JP)

(72) Inventors: Takehiro Ozawa, Tokyo (JP); Kazuma Ohara, Tokyo (JP); Naoki Mori, Tokyo (JP)

(21) Appl. No.: 19/538,905

(22) Filed: Feb. 12, 2026

(30) Foreign Application Priority Data
Feb. 19, 2025 (JP) 2025-024679

(51) Int. Cl. G06T 7/20; G06T 7/00; G06T 7/246; G06T 7/70; G06T 7/73; G06T 7/80

(52) U.S. Cl. CPC G06T 7/20; G06T 7/0002; G06T 7/246; G06T 7/70; G06T 7/73; G06T 7/80

(57) ABSTRACT

A position estimation program performs: dividing a detection region specified by sensor data indicating a situation around a moving body for each type of detection target to generate region information indicating a position of a divided region in the detection region, storing past sensor data in a memory in association with the region information; calculating a divergence degree between a position of a current divided region specified by the region information associated with current sensor data and a position of a past divided region specified by the region information associated with the past sensor data; and estimating a self-position of the moving body based on the divergence degree. The estimating includes, when the divergence degree is equal to or less than a predetermined value, estimating that a current self-position is the same as the self-position at a time of acquisition of the past sensor data.

### CROSS-REFERENCE TO RELATED APPLICATION

This application is based upon and claims the benefit of priority from Japanese Patent Application No. 2025-024679 filed on February 19, 2025, the content of which is incorporated herein by reference.

### BACKGROUND

### Technical Field

The present invention relates to a non-transitory computer readable medium storing a position estimation program for estimating traveling position of a subject vehicle on a map and a moving control program, and to a position estimation apparatus.

### Related Art

Conventionally, as this type of device, there is known a device configured to estimate a self-position of a vehicle by combining image data acquired by a camera and point cloud data acquired by a LiDAR so as to improve robustness of position estimation against an environmental change (see e.g., WO 2024/171624 A). In the device described in WO 2024/171624 A, image data is classified for each pixel using semantic segmentation, and point cloud data corresponding to a region classified as a stationary object and point cloud data constituting map information are scan-matched to estimate a position of a vehicle on a map.

However, if the self-position is estimated by matching the point cloud data as in the device described in WO 2024/171624 A, there is a possibility that a decrease in position estimation accuracy due to an environmental change cannot be sufficiently suppressed.

### SUMMARY

An aspect of the present invention is a non-transitory computer-readable storage medium storing a position estimation program configured to be executed by a computer. The position estimation program causes the computer to perform: acquiring sensor data acquired by a sensor configured to detect a situation around a moving body; dividing a detection region specified by the sensor data for each type of detection target included in the sensor data to generate region information indicating a position of a divided region in the detection region; storing a past sensor data acquired by the sensor in a memory connected to the computer in association with the region information; calculating a divergence degree between a position of a current divided region specified by the region information associated with current sensor data acquired by the sensor and a position of a past divided region specified by the region information associated with past sensor data acquired by the sensor and stored in the memory; and estimating a self-position of the moving body based on the divergence degree calculated. The estimating includes, when the divergence degree is equal to or less than a predetermined value, estimating that a current self-position of the moving body is the same as the self-position at the time point when the past sensor data. The storage medium further stores a moving control program including the above position estimation program. The moving control program causes the computer to perform executing moving control based on the self-position of the mobbing body estimated and the past sensor data stored in the memory.

Another aspect of the present invention is a position estimation apparatus including: a microprocessor; and a memory connected to the microprocessor. The microprocessor is configured to perform: acquiring sensor data acquired by a sensor configured to detect a situation around a moving body; dividing a detection region specified by the sensor data for each type of detection target included in the sensor data to generate region information indicating a position of a divided region in the detection region; storing past sensor data acquired by the sensor in the memory in association with the region information; calculating a divergence degree between a position of a current divided region specified by the region information associated with current sensor data acquired by the sensor and a position of a past divided region specified by the region information associated with past sensor data acquired by the sensor and stored in the memory; and estimating a self-position of the moving body based on the divergence degree calculated. The estimating includes, when the divergence degree is equal to or less than a predetermined value, estimating that a current self-position of the moving body is the same as the self-position at a time point when the past sensor data has been acquired.

### BRIEF DESCRIPTION OF THE DRAWINGS

The objects, features, and advantages of the present invention will become clearer from the following description of embodiments in relation to the attached drawings, in which:

FIG. 1 is a block diagram schematically illustrating an overall configuration of a vehicle control system according to an embodiment of the present invention;

FIG. 2 is a block diagram illustrating a configuration of a main part of the vehicle control apparatus according to the embodiment of the present invention;

FIG. 3A is a diagram illustrating an example of camera image;

FIG. 3B is a diagram illustrating another example of camera image;

FIG. 4 is a diagram for describing acquisition of an image sequence; and

FIG. 5 is a flowchart illustrating an example of a processing executed by the CPU of the controller in FIG. 2.

### DETAILED DESCRIPTION

An embodiment of the invention will be described below with reference to the drawings. A position estimation apparatus according to an embodiment of the present invention is applicable to a vehicle having a self-driving capability, that is, a self-driving vehicle. Note that a vehicle to which the position estimation apparatus according to the present embodiment is applied may be referred to as a subject vehicle to be distinguished from other vehicles. The subject vehicle may be any of an engine vehicle having an internal combustion engine (engine) as a traveling drive source, an electric vehicle having a traveling motor as the traveling drive source, and a hybrid vehicle having an engine and a traveling motor as the traveling drive source. The subject vehicle can travel not only in a self-drive mode in which driving operation by a driver is unnecessary, but also in a manual drive mode with driving operation by the driver.

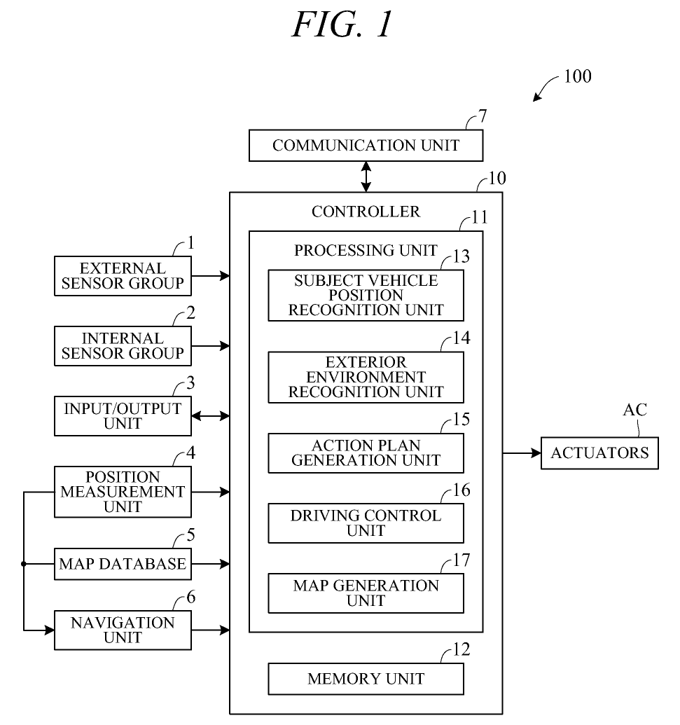

First, a schematic configuration of the subject vehicle related to self-driving will be described. FIG. 1 is a block diagram schematically illustrating an overall configuration of a vehicle control system 100 of the subject vehicle including the position estimation apparatus according to the present embodiment. As illustrated in FIG. 1, the vehicle control system 100 mainly includes a controller 10, an external sensor group 1, an internal sensor group 2, an input/output device 3, a position measurement unit 4, a map database 5, a navigation unit 6, a communication unit 7, and traveling actuators AC each communicably connected to the controller 10.

The external sensor group 1 is a generic term for a plurality of sensors (external sensors) that detect an external situation which is peripheral information of the subject vehicle. For example, the external sensor group 1 includes a LiDAR that measures reflected light with respect to irradiation light in all directions of the subject vehicle and measures the distance from the subject vehicle to surrounding obstacles, a radar that detects other vehicles, obstacles, and the like around the subject vehicle by irradiating electromagnetic waves and detecting reflected waves, and a camera that is installed in the subject vehicle, has an imaging element (image sensor) such as a charge coupled device (CCD) or a complementary metal oxide semiconductor (CMOS), and captures images of the surrounding (front, rear, and side) of the subject vehicle.

The internal sensor group 2 is a generic term for a plurality of sensors (internal sensors) that detect a traveling state of the subject vehicle. For example, the internal sensor group 2 includes an inertial measurement unit (IMU) or the like that detects rotational angular velocity around three axes in a vertical direction at the center of gravity of the subject vehicle, a front-rear direction (advancing direction) of the subject vehicle, and a lateral direction (vehicle-width direction) of the subject vehicle, and accelerations in the directions of three axes. The internal sensor group 2 also includes a sensor that detects a driver's driving operation in the manual drive mode, for example, an operation of an accelerator pedal, an operation of a brake pedal, an operation of a steering wheel, or the like.

The input/output device 3 is a generic term for devices to which a command is input from the driver or information is output to the driver. For example, the input/output device 3 includes various switches to which the driver inputs various commands by operating an operation member, a microphone to which the driver inputs a command by voice, a display that provides information to the driver via a display image, and a speaker that provides information to the driver by voice.

The position measurement unit (global navigation satellite system (GNSS) unit) 4 has a positioning sensor that receives a positioning signal transmitted from a positioning satellite. The positioning satellite is an artificial satellite such as a global positioning system (GPS) satellite or a quasi-zenith satellite. The position measurement unit 4 uses positioning information received by the positioning sensor to measure a current position (latitude, longitude, and altitude) of the subject vehicle.

The map database 5 is a device that stores general map information used for the navigation unit 6, and includes, for example, a hard disk or a semiconductor element. The map information includes road position information, information on a road shape (curvature or the like), and position information on intersections and branch points. The map information stored in the map database 5 is different from high-precision map information stored in the memory unit 12 of the controller 10.

The navigation unit 6 is a device that searches for a target route to a destination on a road which is entered by a driver and guides the driver along the target route. The input of the destination and the guidance along the target route are performed via the input/output device 3. The target route is calculated on the basis of a current position of the subject vehicle measured by the position measurement unit 4 and the map information stored in the map database 5. The current position of the subject vehicle can be measured using the detection values of the external sensor group 1, and the target route may be calculated on the basis of the current position and the high-precision map information stored in the memory unit 12.

The communication unit 7 communicates with various servers not illustrated via a network including wireless communication networks represented by the Internet, a mobile telephone network, and the like, and acquires the map information, travel history information, traffic information, and the like from the servers periodically or at an arbitrary timing. The travel history information of the subject vehicle may be transmitted to the server via the communication unit 7 in addition to the acquisition of the travel history information. The network includes not only a public wireless communication network but also a closed communication network provided for each of predetermined management areas, for example, a wireless LAN, Wi-Fi (registered trademark), Bluetooth (registered trademark), and the like. The acquired map information is output to the map database 5 and the memory unit 12, and the map information is updated.

The actuators AC are traveling actuators for controlling traveling of the subject vehicle. In a case where the traveling drive source is an engine, the actuators AC include a throttle actuator that adjusts an opening (throttle opening) of a throttle valve of the engine. In a case where the traveling drive source is a traveling motor, the actuators AC includes the traveling motor. The actuators AC include a brake actuator that operates the braking device in the subject vehicle and a steering actuator that drives the steering device.

The controller 10 includes an electronic control unit (ECU). More specifically, the controller 10 includes a computer including a processing unit 11 such as a CPU (microprocessor), the memory unit 12 such as a ROM and a RAM, and other peripheral circuits (not illustrated) such as an I/O interface. Although a plurality of ECUs having different functions such as an engine control ECU, a traveling motor control ECU, and a braking device ECU can be separately provided, in FIG. 1, the controller 10 is illustrated as a set of these ECUs for convenience.

The memory unit 12 stores highly precise detailed map information (referred to as high-precision map information). The high-precision map information includes information on the position of roads, road geometry (curvature and others), road gradients, positions of intersections and junctions, types and positions of road division lines such as white lines, number of lanes, lane width and position of each lane (center position of lanes and boundaries of lane positions), positions of landmarks (buildings, traffic lights, signs, and others) on maps, and road surface profiles such as road surface irregularities. In the embodiment, center lines, lane lines, outside lines, and the like are collectively referred to as road division lines. The high-precision map information stored in the memory unit 12 includes map information (referred to as external map information) that has been acquired from the outside of the subject vehicle via the communication unit 7, and a map (referred to as internal map information) created by the subject vehicle itself using detection values by the external sensor group 1 or detection values of the external sensor group 1 and the internal sensor group 2.

The external map information is, for example, information of a map that has been acquired via a cloud server (referred to as a cloud map), and the internal map information is, for example, information of a map (referred to as an environmental map) including three-dimensional point cloud data generated by mapping using a technology such as simultaneous localization and mapping (SLAM), for example. The external map information is shared among the subject vehicle and other vehicles, whereas the internal map information is map information that is exclusive to the subject vehicle (for example, map information that the subject vehicle owns by itself). For roads on which the subject vehicle has never traveled, newly constructed roads, and the like, environmental maps are created by the subject vehicle itself. Note that the internal map information may be provided to a server device or other vehicles via the communication unit 7. In addition to the above-described high-precision map information, the memory unit 12 also stores traveling trajectory information of the subject vehicle, various control programs, and thresholds for use in the programs.

The processing unit 11 includes a subject vehicle position recognition unit 13, an exterior environment recognition unit 14, an action plan generation unit 15, a driving control unit 16, and a map generation unit 17 as functional configurations.

The subject vehicle position recognition unit 13 recognizes (or estimates) the position (subject vehicle position) of the subject vehicle on a map, on the basis of the position information of the subject vehicle, obtained by the position measurement unit 4, and the map information of the map database 5. The subject vehicle position may be recognized (estimated) using the high-precision map information stored in the memory unit 12 and the peripheral information of the subject vehicle detected by the external sensor group 1, whereby the subject vehicle position can be recognized with high accuracy. The movement information (moving direction, moving distance) of the subject vehicle may be calculated on the basis of the detection values by the internal sensor group 2, and the subject vehicle position may be recognized accordingly. When the subject vehicle position can be measured by a sensor installed on a road or outside a road side, the subject vehicle position can be recognized by communicating with the sensor via the communication unit 7.

The exterior environment recognition unit 14 recognizes an external situation around the subject vehicle on the basis of signals from the external sensor group 1 such as the LiDAR, the radar, and the camera. For example, the position, speed, and acceleration of a surrounding vehicle (a forward vehicle or a rearward vehicle) traveling around the subject vehicle, the position of a surrounding vehicle stopped or parked around the subject vehicle, the positions and states of other objects, and the like are recognized. Other objects include signs, traffic lights, markings such as division lines and stop lines of roads, buildings, guardrails, utility poles, signboards, pedestrians, bicycles, and the like. The states of other objects include a color (red, green, yellow) of a traffic light, and the moving speed and direction of a pedestrian or a bicycle. A part of the stationary object among the other objects constitutes a landmark serving as an index of the position on the map, and the exterior environment recognition unit 14 also recognizes the position and type of the landmark.

The action plan generation unit 15 generates a driving path (target path) of the subject vehicle from a current point of time to a predetermined time ahead on the basis of, for example, the target route calculated by the navigation unit 6, the high-precision map information stored in the memory unit 12, the subject vehicle position recognized by the subject vehicle position recognition unit 13, and the external situation recognized by the exterior environment recognition unit 14. When there is a plurality of paths that are candidates for the target path on the target route, the action plan generation unit 15 selects, from among the plurality of paths, an optimal path that satisfies criteria such as compliance with laws and regulations, and efficient and safe traveling, and sets the selected path as the target path. Then, the action plan generation unit 15 generates an action plan corresponding to the generated target path. The action plan generation unit 15 generates various action plans corresponding to passing traveling for passing a preceding vehicle, lane change traveling for changing a travel lane, tracking traveling for tracking a preceding vehicle, lane keeping traveling for keeping a lane without departing from a travel lane, deceleration traveling or acceleration traveling, and the like. When the target path is generated, first, the action plan generation unit 15 determines a travel mode, and then generates the target path on the basis of the travel mode.

In the self-drive mode, the driving control unit 16 controls each of the actuators AC such that the subject vehicle travels along the target path generated by the action plan generation unit 15. More specifically, the driving control unit 16 calculates a requested drive force for obtaining target acceleration for each unit time calculated by the action plan generation unit 15 in consideration of traveling resistance determined according to a road gradient or the like in the self-drive mode. Then, for example, the actuators AC are feedback controlled so that an actual acceleration detected by the internal sensor group 2 becomes the target acceleration. More specifically, the actuators AC are controlled so that the subject vehicle travels at a target vehicle speed and the target acceleration. In the manual drive mode, the driving control unit 16 controls each of the actuators AC in accordance with a travel command (steering operation or the like) from the driver acquired by the internal sensor group 2.

The map generation unit 17 generates an environmental map in the surroundings of the road on which the subject vehicle has traveled, as internal map information, by using the detection values that have been detected by the external sensor group 1 while the subject vehicle is traveling in the manual drive mode. For example, an edge indicating an outline of an object or a characteristic region (blob) is extracted from a plurality of frames of camera images that have been acquired by the camera, on the basis of luminance and color information for each of pixels, and feature points are extracted with use of such edge or blob information. The feature points are, for example, intersections of edges, and correspond to corners of buildings, corners of road signs, or the like. The map generation unit 17 calculates a three-dimensional position of a feature point while estimating the position and posture of the camera so that identical feature points converge on a single point in a plurality of frames of camera images, in accordance with the algorithm of the SLAM technology. By performing this calculation processing for each of the plurality of feature points, an environmental map including the three-dimensional point cloud data is generated. Note that the environmental map may be generated by extracting feature points of objects around the subject vehicle using data acquired by a radar or LiDAR instead of a camera.

The subject vehicle position recognition unit 13 may perform subject vehicle position recognition processing on the basis of the environmental map generated by the map generation unit 17 and the feature points that have been extracted from the camera image. Accordingly, after the environmental map is generated, when the subject vehicle travels at a location corresponding to the stored environmental map, the position recognition processing of the subject vehicle can be performed based on the stored environmental map. In addition, the subject vehicle position recognition unit 13 may perform the subject vehicle position recognition processing in parallel with the map creation processing by the map generation unit 17. The map creation processing and the position recognition (estimation) processing are simultaneously performed in accordance with the algorithm of the SLAM technology. The map generation unit 17 is capable of generating the environmental map not only when traveling in the manual drive mode but also when traveling in the self-drive mode. In a case where the environmental map has already been generated and stored in the memory unit 12, the map generation unit 17 may update the environmental map, on the basis of a newly extracted feature point from a newly acquired camera image.

As a method of estimating a subject vehicle position (self-position of the vehicle), there is a method of estimating the self-position of the vehicle on an environmental map by matching a feature point cloud extracted from a camera image with three-dimensional point cloud data included in the environmental map. However, the feature point extracted from the camera image is likely to change depending on the environment (illuminance etc.) around the vehicle. Therefore, even in the camera images acquired at the same driving position, if the acquisition time zone, the weather at the time of acquisition, and the like are different, the extracted feature points may not coincide with each other. In this case, there is a possibility that the self-position of the vehicle cannot be accurately estimated. Therefore, in order to cope with such a problem, the position estimation apparatus according to the present embodiment is configured as follows.

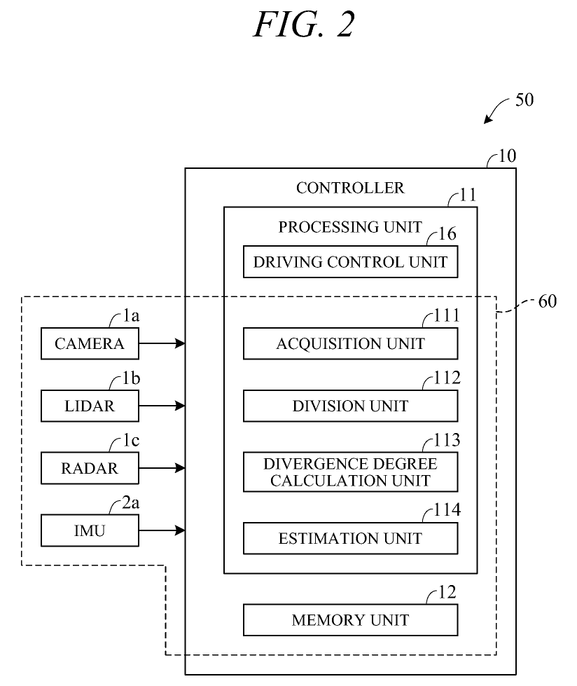

FIG. 2 is a block diagram illustrating a configuration of a main part of the vehicle control device 50 according to the present embodiment. The vehicle control device 50 constitutes a part of the vehicle control system 100 in FIG. 1. As illustrated in FIG. 2, the vehicle control device 50 includes a controller 10, a camera 1a, a LiDAR 1b, and a radar 1c. In addition, the vehicle control device 50 includes a position estimation apparatus 60, which constitutes a part of the vehicle control device 50. The position estimation apparatus 60 estimates the driving position of the subject vehicle on the map based on the detection data (camera image) of the camera 1a.

The camera 1a is a monocular camera including an imaging element (image sensor) such as a CCD or a CMOS, and constitutes a part of the external sensor group 1 in FIG. 1. The camera 1a detects a situation around the subject vehicle. The camera 1a is attached to, for example, a predetermined position in a front part of the subject vehicle, continuously images a space ahead of the subject vehicle at a predetermined frame rate, and sequentially outputs frame image data (camera images) serving as detection information to the controller 10. Note that the camera 1a may be a stereo camera.

The LiDAR 1b is mounted on the subject vehicle, measures scattered light with respect to irradiation light in all directions of the subject vehicle, and detects a distance from the subject vehicle to an obstacle in the surroundings. The LiDAR 1b outputs the detection value (detection data) to the controller 10. The radar 1c is mounted on the subject vehicle and detects other vehicles, obstacles, and the like around the subject vehicle by emitting electromagnetic waves and detecting reflected waves. The radar 1c outputs the detection value (detection data) to the controller 10.

The controller 10 includes a processing unit 11 and a memory unit 12. The processing unit 11 includes, as functional configurations, an acquisition unit 111, a division unit 112, a divergence degree calculation unit 113, an estimation unit 114, and a driving control unit 16.

The acquisition unit 111, the division unit 112, and the divergence degree calculation unit 113 are configured by, for example, the subject vehicle position recognition unit 13 in FIG. 1. For example, the estimation unit 114 is configured by the subject vehicle position recognition unit 13 and the map generation unit 17 in FIG. 1. The acquisition unit 111, the division unit 112, the divergence degree calculation unit 113, the estimation unit 114, the camera 1a, the LiDAR 1b, the radar 1c, the IMU 2a, and the memory unit 12 are included in the position estimation apparatus 60.

The acquisition unit 111 acquires the camera image acquired by the camera 1a. More specifically, the acquisition unit 111 continuously acquires camera images while the subject vehicle is traveling (moving).

The division unit 112 executes region division processing of dividing the imaging region specified by the camera image by classifying the imaging region for each pixel of the imaging region. Specifically, the division unit 112 divides the imaging region specified by the camera image into classes in units of pixels, and partitions the imaging region for each region (hereinafter referred to as a divided region) consisting of pixels classified into the same class. The class is, for example, "vehicle", "road", "building", "shrubbery", "background", or the like. Semantic segmentation may be used for the division of the imaging region, or other segmentation techniques may be used.

The division unit 112 generates region information indicating the position of the divided region in the imaging region, and stores the region information in the memory unit 12. At this time, the division unit 112 stores the camera image used to generate the region information in the memory unit 12 in association with the region information.

The divergence degree calculation unit 113 compares the position of each divided region specified by the region information generated based on the current camera image acquired by the acquisition unit 111 with the position of each divided region specified by the region information associated with the past camera image stored in the memory unit 12.

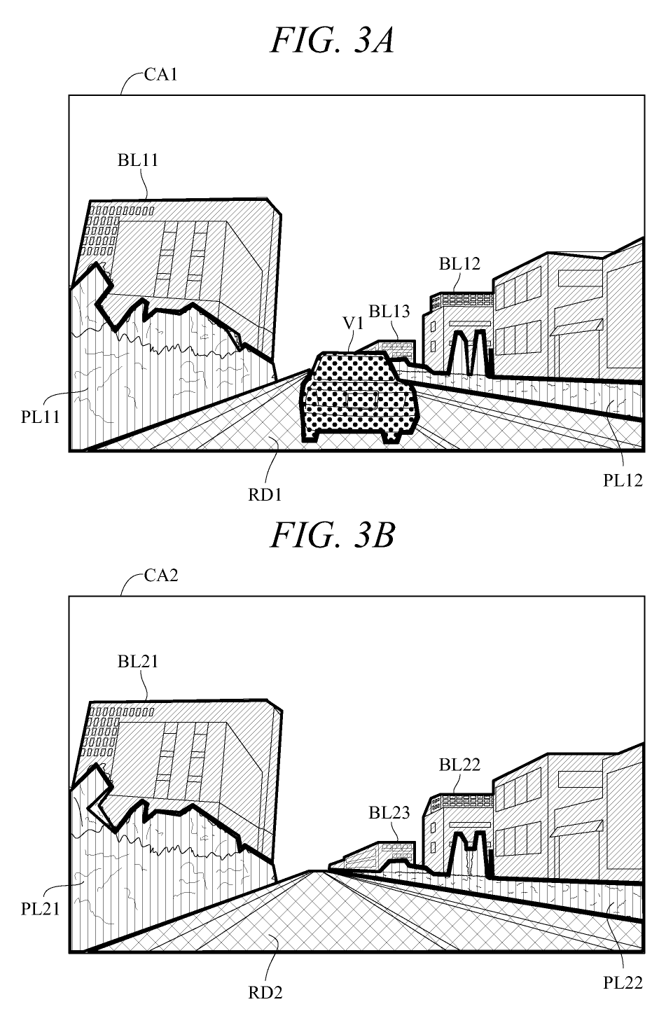

FIGS. 3A and 3B are diagrams illustrating examples of camera images acquired by the camera 1a. A region CA1 in FIG. 3A is an imaging region specified by the current camera image acquired by the acquisition unit 111. A region CA2 in FIG. 3B is an imaging region specified by a past camera image acquired from the same driving position as the driving position where the camera image in FIG. 3A is acquired. Regions BL11, BL12, BL13, VC1, RD1, PL11, and PL12 in FIG. 3A are divided regions obtained by dividing the imaging region CA1. Regions BL21, BL22, BL23, RD2, PL21, and PL22 in FIG. 3B are divided regions obtained by dividing the imaging region CA2.

Each of the divided regions BL11, BL12, BL13, BL21, BL22, and BL23 is a region consisting of pixels classified as "building". Each of the divided regions RD1 and RD2 is a region consisting of pixels classified as “road”. The divided regions PL11, PL12, PL21, and PL22 are regions consisting of pixels classified as “shrubbery”. The divided region VC1 is a region consisting of pixels classified as "vehicle".

The divergence degree calculation unit 113 calculates the overlapping degree between the divided region (hereinafter referred to as a comparison source region) included in the imaging region of the current camera image and the divided region (hereinafter referred to as a comparison target region) included in the imaging region of the past camera image and classified into the same class as the comparison source region. Specifically, the divergence degree calculation unit 113 calculates an Intersection over Union (IOU) which is an index for evaluating the overlapping degree of the regions. The IOU is represented by a numerical value between 0.0 and 1.0. 0.0 represents a state in which the comparison source region and the comparison target region do not overlap at all, and 1.0 represents a state in which both regions completely overlap.

The divergence degree calculation unit 113 performs the IOU for each class. In the examples of FIGS. 3A and 3B, the IOUs of the divided regions BL11, BL12, and BL13 and the divided regions BL21, BL22, and BL23 are calculated. In addition, the IOU between the divided region RD1 and the divided region RD2 is calculated. Furthermore, the IOUs between the divided regions PL11 and PL12 and the divided regions PL21 and PL22 are calculated. Note that a region (e.g., divided region V1 in FIG. 3A) consisting of pixels classified as a moving object such as a “vehicle” is excluded from an IOU calculation target. The exclusion of the moving object may be performed before the region division. In addition, the class of the moving object may be determined to be the same class as any other class.

The divergence degree calculation unit 113 sets (calculates) the divergence degree between the position of each divided region corresponding to the current camera image and the position of each divided region corresponding to the past camera image so as to be smaller the larger the IOU. A method of setting the divergence degree may be a given method, and as an example, the divergence degree calculation unit 113 may calculate an average value (hereinafter referred to as an IOU average value) a of the IOUs by averaging the IOUs calculated for each class, and may calculate a complement (1 - a) thereof as the divergence degree.

Note that in some cases, the driving positions of the subject vehicle in the vehicle width direction do not coincide with each other between the past driving and the current driving. For example, when the road illustrated in FIGS. 3A and 3B is a two-lane road on each side, the driving position of the subject vehicle in the vehicle width direction is different between when the subject vehicle is traveling in the left lane and when the subject vehicle is traveling in the right lane. In this case, even if the driving position in the advancing direction of the subject vehicle is the same, the imaging region specified by the current camera image and the imaging region specified by the past camera image are shifted in the vehicle width direction, and thus, there is a possibility that the IOU cannot be accurately calculated.

Therefore, when calculating the IOU, the divergence degree calculation unit 113 performs width direction adjustment for adjusting the imaging region specified by the current camera image in the vehicle width direction (horizontal axis direction in the camera image). Specifically, the divergence degree calculation unit 113 repeatedly calculates the IOU average value a while offsetting the imaging region specified by the current camera image from the imaging region specified by the past camera image by a designated amount (e.g., n pixels) in the vehicle width direction. Then, the divergence degree calculation unit 113 calculates the complement of the largest IOU average value a among the calculated IOU average values a as the divergence degree.

The estimation unit 114 searches for, from the past camera images stored in the memory unit 12, a past camera image having the smallest divergence degree calculated by the divergence degree calculation unit 113, that is, a past camera image having the highest degree of coincidence with the current camera image. When a target past camera image is specified as a result of the search, the estimation unit 114 determines whether or not the divergence degree of the specified past camera image is equal to or less than a predetermined value. When the divergence degree is equal to or less than the predetermined value, the estimation unit 114 estimates that the current self-position of the subject vehicle, that is, the self-position at the time point when the current camera image is acquired is the same as the self-position at the time point when the specified past camera image is acquired.

Note that, on the road on which the vehicle travels, there may exist a section where similar scenery continues, or there may exist a point where the scenery is similar to that of another point. When the subject vehicle is traveling on such a road, there is a possibility that a plurality of past camera images corresponding to the current camera image are specified in the search. In this case, a past camera image acquired at a position different from the current self-position of the subject vehicle is used for self-position estimation, and an error may occur in the estimation result.

Therefore, the estimation unit 114 executes the above search using not a single camera image but a series of camera images (continuous frame images) acquired while the subject vehicle travels a predetermined distance so as to suppress such an error in the self-position estimation. Here, the search using a series of camera images will be described.

When the subject vehicle travels a predetermined distance, the acquisition unit 111 acquires a series of camera images (hereinafter referred to as an image sequence) acquired by the camera 1a during the traveling. The acquisition unit 111 measures the driving distance of the subject vehicle by odometry. Specifically, the acquisition unit 111 estimates the movement amount and the moving direction of the subject vehicle based on the acceleration and the angular velocity detected by the IMU 2a, and calculates the driving distance of the subject vehicle. Note that the acquisition unit 111 may measure the driving distance of the subject vehicle based on a detection value of a vehicle speed sensor, a yaw rate sensor, or the like (not illustrated).

The division unit 112 generates region information corresponding to the individual camera image included in the image sequence, and stores the image sequence and the region information corresponding to the individual camera image in the memory unit 12 in association with each other. As a result, every time the subject vehicle travels a predetermined distance, the image sequence and the region information corresponding thereto are stored in the memory unit 12.

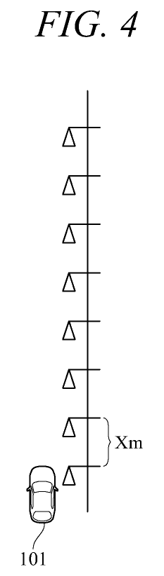

FIG. 4 is a diagram for describing acquisition of an image sequence. A triangle mark in the drawing schematically indicates a timing at which the image sequence is stored in the memory unit 12. As illustrated in FIG. 4, when the subject vehicle 101 travels a predetermined distance X (m), a camera image (image sequence) acquired by the camera 1a during the traveling is stored in the memory unit 12. In this manner, the image sequence corresponding to the road on which the subject vehicle 101 is traveling is stored in the memory unit 12 for each section of X meters.

The divergence degree calculation unit 113 compares the current image sequence acquired by the acquisition unit 111 with a plurality of past image sequences stored in the memory unit 12, and calculates each of the comparison results (divergence degrees).

When calculating the divergence degree between the current image sequence and the past image sequence, the divergence degree calculation unit 113 first specifies the past camera image having the largest IOU (the smallest divergence degree) with the individual camera image included in the current image sequence from the plurality of stored past camera images. That is, a set of corresponding camera images (a current camera image and a past camera image) is specified between the current image sequence and the stored plurality of past camera images. Then, if there is no contradiction between the time series of the current camera image and the time series of the past camera image corresponding to the current camera image, it is specified that the past image sequence including the corresponding past camera image corresponds to the current image sequence. Note that the set of corresponding camera images may be specified based on other criteria. The divergence degree calculation unit 113 calculates the divergence degree of each set of the specified camera images and calculates an average value thereof as the divergence degree between the image sequences.

When calculating the divergence degree of each specified set of the camera images, the divergence degree calculation unit 113 applies the width direction adjustment to each set. At this time, the divergence degree calculation unit 113 may use the adjustment amount (offset amount in the vehicle width direction) of the set to which the width direction adjustment is first applied for the width direction adjustment of another set.

The estimation unit 114 searches for a past image sequence having the smallest divergence degree calculated by the divergence degree calculation unit 113, that is, a past image sequence having the highest degree of coincidence with the current image sequence, from the past image sequences stored in the memory unit 12. As described above, by performing the search using a series of camera images instead of a single camera image, the accuracy of the search can be improved, and the error in the estimation result in the self-position estimation as described above can be suppressed.

The estimation unit 114 determines whether or not the divergence degree of the specified past image sequence is equal to or less than a predetermined value. If the divergence degree is equal to or less than the predetermined value, the estimation unit 114 estimates that the current self-position of the subject vehicle, that is, the self-position at the time point when the current image sequence is acquired is the same as the self-position at the time point when the specified past image sequence is acquired.

When the estimated self-position is out of the range of the environmental map stored in the memory unit 12, specifically, when information (point cloud data) corresponding to the estimated self-position does not exist in the environmental map, the estimation unit 116 updates the environmental map based on the current image sequence. Specifically, the estimation unit 116 updates the environmental map stored in the memory unit 12 based on the feature point cloud extracted from each camera image included in the current image sequence. As a result, when the subject vehicle travels at least twice on a road that does not exist in the environmental map, map information corresponding to the road is automatically added to the environmental map.

The driving control unit 16 performs driving control of the subject vehicle based on the self-position of the subject vehicle estimated by the estimation unit 116. Specifically, the driving control unit 16 controls each actuator AC so that the subject vehicle travels along the target path generated by the action plan generation unit 15 based on the self-position of the subject vehicle estimated by the estimation unit 116.

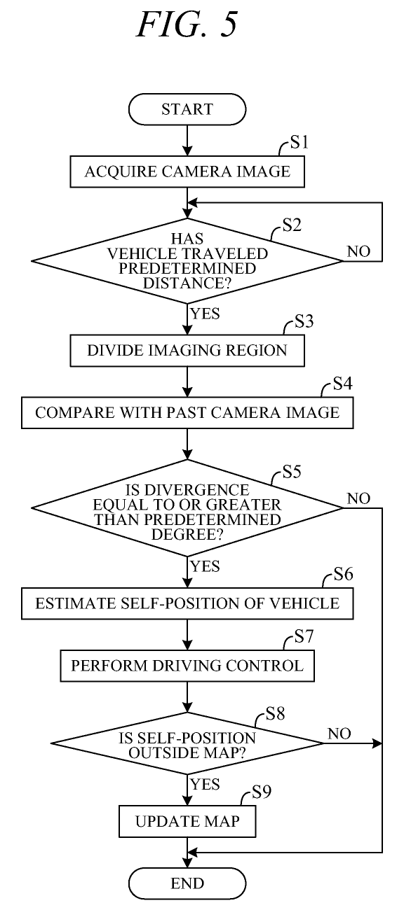

FIG. 5 is a flowchart illustrating an example of processing executed by the CPU of the controller 10 in FIG. 2 in accordance with a predetermined program.

The processing illustrated in this flowchart is started when the vehicle control system 100 is activated, and is repeated at a predetermined cycle while the vehicle control system 100 is activated. Specifically, the processing is repeated every time the camera image is input from the camera 1a, that is, at a time interval defined by the frame rate of the camera 1a. Note that the predetermined cycle may be variable instead of being constant in consideration of necessity for traffic safety, calculation load, and the like.

First, in step S1, the controller 10 acquires a camera image. In step S2, the controller 10 determines whether the subject vehicle has traveled a predetermined distance. Specifically, the controller 10 determines whether or not the measurement value D of the driving distance of the subject vehicle has reached the predetermined distance X. The initial value of the measurement value D is zero. When the determination in step S2 is negative, the controller 10 stores the camera image acquired in step S1 in the memory unit 12, and repeats the processing in step S2 until an affirmative determination is made. When the determination in step S2 is affirmative, the camera image acquired in step S1 is stored in the memory unit 12, and the processing proceeds to step S3. At this time, the controller 10 resets the measurement value D to 0.

In step S3, the controller 10 executes region division processing on the camera image (current image sequence) stored in the memory unit 12 while the subject vehicle travels a predetermined distance. The controller 10 stores the region information indicating the result of the region division processing in the memory unit 12 in association with the current image sequence.

In step S4, the controller 10 compares the current image sequence with a plurality of past image sequences stored in the memory unit 12, and calculates each comparison result (divergence degree). In step S5, the controller 10 specifies a past image sequence having the smallest divergence degree from among a plurality of past image sequences, and determines whether or not the divergence degree of the specified past image sequence is equal to or less than a predetermined value.

When the determination in step S5 is negative, the controller 10 ends the processing. When the determination is in step S5 is affirmative, the controller 10 estimates a current self-position of the subject vehicle in step S6. Specifically, it is estimated that the self-position at the time point the current image sequence is acquired is the same as the self-position at the time point when the past image sequence specified in step S5 is acquired. In step S7, the controller 10 performs driving control of the subject vehicle based on the self-position estimated in step S6.

In step S8, the controller 10 determines whether or not the self-position estimated in step S6 is included in the environmental map stored in the memory unit 12. When the determination in step S8 is negative, the controller 10 ends the processing. When the determination in step S8 is affirmative, the controller 10 updates the environmental map based on the current image sequence in step S9. Specifically, the environmental map is updated based on the feature point cloud extracted from each camera image included in the current image sequence.

According to the above-described embodiment, the following effects can be achieved.

(1) The position estimation apparatus 60 includes an acquisition unit 111 configured to acquire a camera image acquired by a camera 1a that detects a situation around the subject vehicle, and a division unit 112 configured to divide an imaging region specified by the camera image for each type of detection target included in the imaging region, generate region information indicating a position of the divided region in the imaging region, and store a past camera image acquired by the acquisition unit 111 in a memory unit 12 in association with the region information. The division unit 112 classifies each pixel constituting the camera image based on the type of the detection target corresponding to each pixel, and divides the imaging region based on the classification result. The position estimation apparatus 60 further includes a divergence degree calculation unit 113 configured to calculate a divergence degree between the position of the current divided region specified by the region information associated with the current camera image acquired by the acquisition unit 111 and the position of the past divided region specified by the region information associated with the past camera image stored in the memory unit 12, and an estimation unit 114 configured to estimate the self-position of the subject vehicle based on the divergence degree calculated by the divergence degree calculation unit 113. When the divergence degree is equal to or less than the predetermined value, the estimation unit 114 estimates that the current self-position of the subject vehicle is the same as the self-position at the time point when the past camera image is acquired.

As described above, the comparison of the regions is performed on the current camera image and the past camera image instead of the comparison of the feature points, and the self-position is estimated based on the comparison result, whereby the self-position estimation with high robustness against the environmental change such as day and night can be performed. As a result, the self-position of the subject vehicle can be accurately estimated.

(2) The divergence degree calculation unit 113 calculates the divergence degree based on the overlapping degree between the divided region of the past camera image and the divided region of the current camera image divided as the same type of region as the divided region. In this manner, the robustness of the self-position estimation with respect to the environmental change is further improved by calculating the divergence degree based on the positional relationship of the divided regions corresponding between the camera images.

(3) The acquisition unit 111 continuously acquires camera images while the subject vehicle is traveling(moving), the divergence degree calculation unit 113 searches for a series of past camera images having the smallest divergence degree from a series of current camera images acquired while the subject vehicle moves by a predetermined distance from the past camera images stored in the memory unit 12, and the estimation unit 114 estimates that the current self-position of the subject vehicle is the same as the self-position at the time when the series of past camera images is acquired when the divergence degree between the series of current camera images and the series of past camera images specified by the search is equal to or less than a predetermined value. In this manner, by calculating the divergence degree by comparing the image sequences for each predetermined distance that does not depend on the driving speed of the subject vehicle, the self-position can be accurately estimated even in a case where the current driving speed of the subject vehicle is different from the driving speed at the time of acquiring the past image sequence.

(4) The estimation unit 114 repeatedly calculates the divergence degree while offsetting (shifting) the imaging region specified by the current camera image in the width direction of the subject vehicle by a designated amount with respect to the imaging region specified by the past camera image, and estimates the self-position of the subject vehicle based on the smallest divergence degree among the calculated divergence degrees. By performing such width direction adjustment, the self-position can be accurately estimated even when the driving position of the subject vehicle in the vehicle width direction at the time point when the current camera image is acquired is different from that at the time point when the past camera image is acquired.

(5) The camera 1a images a space located in a specific direction with respect to the subject vehicle, specifically, a space in front of the subject vehicle. Both the current camera image and the past camera image are acquired by the camera 1a. In this manner, the estimation accuracy can be improved by estimating the self-position based on the current camera image and the past camera image acquired by the same in-vehicle camera.

(6) The position estimation apparatus 60 further includes a driving control unit 16 configured to perform driving control (movement control) of the subject vehicle. The driving control unit 16 performs driving control based on the self-position of the subject vehicle estimated by the estimation unit 114 and the stored past camera images. As described above, the driving path of the subject vehicle can be appropriately maintained by reflecting the accurately estimated self-position on the driving control of the subject vehicle.

(7) The estimation unit 114 stores the current camera image when the estimated self-position is outside the range of the past camera image stored in the memory unit 12. As a result, information regarding the roads that do not exist in the environmental map can be automatically added to the environmental map.

The above embodiment can be modified in various modes. Hereinafter, modified examples will be described. In the above embodiment, the acquisition unit 111 acquires the sensor data (camera image) of the camera 1a serving as the sensor, and the division unit 112 divides the detection region (imaging region) of each pixel constituting the camera image based on the type of the detection target corresponding to each pixel. However, the sensor may be other than the camera 1a, and the acquisition unit may acquire sensor data (point cloud data) of the LiDAR 1b or the radar 1c at a predetermined cycle. The division unit may classify each measurement point included in the point cloud data based on the type of the detection target corresponding to each measurement point, and divide the detection region based on the classification result.

In the above embodiment, the acquisition unit 111 acquires the camera image acquired by the camera 1a in which the space in front of the subject vehicle is the detection target (imaging target). However, the acquisition unit may acquire, together with the camera image acquired by the camera 1a, a camera image acquired by a camera that is attached to a predetermined position in the rear part of the subject vehicle and in which the space behind the subject vehicle is the imaging target. According to such a configuration, in the processing of step S9, not only the map information corresponding to the lane on which the subject vehicle is traveling but also the map information corresponding to the opposite lane can be added to the environmental map. In addition, even when the vehicle travels in a direction opposite to the advancing direction at the time of creating the environmental map, the self-position can be estimated using the created environmental map.

In the above embodiment, the example in which the moving body to which the position estimation apparatus is applied is a vehicle has been described, but the moving body may be other than a vehicle. Furthermore, in the above embodiment, the vehicle control device 50 and the position estimation apparatus 60 are applied to the self-driving vehicle, but the vehicle control device 50 and the position estimation apparatus 60 are also applicable to vehicles other than the self-driving vehicle. For example, the vehicle control device 50 and the position estimation apparatus 60 can also be applied to a manual driving vehicle including Advanced driver-assistance systems (ADAS).

As another point of view, the position estimation apparatus of the above embodiment can be configured as a position estimation method for estimating the driving position of the subject vehicle on the map. That is, the position estimation method includes an acquisition step of acquiring sensor data acquired by a sensor that detects a situation around a moving body, a division step of dividing a detection region specified by the sensor data for each type of detection target included in the detection region and generating region information indicating a position of a divided region in the detection region, a storage step of storing past sensor data acquired in the acquisition step in a memory unit in association with the region information, a calculation step of calculating a divergence degree between a position of a current divided region specified by the region information associated with the current sensor data acquired in the acquisition step and a position of a past divided region specified by the region information associated with the past sensor data stored in the memory unit, and an estimation step of estimating a self-position of the moving body based on the divergence degree calculated in the calculation step, in which in the estimation step, the current self-position of the moving body is estimated to be the same as the self-position at the time point when the past sensor data is acquired when the divergence degree is equal to or less than a predetermined value.

Furthermore, the present invention can be configured by replacing the above position estimation method with a program (position estimation program) for causing a computer to execute processing of estimating a driving position of the subject vehicle on a map. Furthermore, the present invention can be configured by replacing the program with a computer-readable storage medium in which the program is recorded.

The above embodiment can be combined as desired with one or more of the aforesaid modifications. The modifications can also be combined with one another.

According to the present invention, the self-position of the vehicle can be accurately estimated.

Above, while the present invention has been described with reference to the preferred embodiments thereof, it will be understood, by those skilled in the art, that various changes and modifications may be made thereto without departing from the scope of the appended claims.

What is claimed is:

1. A non-transitory computer-readable storage medium storing a position estimation program configured to be executed by a computer, wherein
the position estimation program causes the computer to perform:
acquiring sensor data acquired by a sensor configured to detect a situation around a moving body;
dividing a detection region specified by the sensor data for each type of detection target included in the sensor data to generate region information indicating a position of a divided region in the detection region;
storing past sensor data acquired by the sensor in a memory connected to the computer in association with the region information;
calculating a divergence degree between a position of a current divided region specified by the region information associated with current sensor data acquired by the sensor and a position of a past divided region specified by the region information associated with the past sensor data acquired by the sensor and stored in the memory; and
estimating a self-position of the moving body based on the divergence degree calculated, wherein
the estimating includes, when the divergence degree is equal to or less than a predetermined value, estimating that a current self-position of the moving body is the same as the self-position at a time point when the past sensor data has been acquired.

2. The storage medium according to claim 1, wherein
the sensor data is image data acquired by a camera or a point cloud data acquired by a Lidar,
the dividing includes dividing the detection region based on the type of the detection target corresponding to each element constituting the sensor data, and
each element is each pixel constituting the image data or each measurement point constituting the point cloud data.

3. The storage medium according to claim 2, wherein
the calculating includes calculating the divergence degree based on an overlapping degree between the past divided region and the current divided region divided as the same type of region as the past divided region.

4. The storage medium according to claim 1, wherein
the acquiring includes continuously acquiring the sensor data while the moving body is moving,
the position estimation program causes the computer to further perform
searching for a series of the past sensor data having the smallest divergence degree from a series of the current sensor data acquired while the moving body moves by a predetermined distance, from the past sensor data stored in the memory, and
the estimating includes estimating that the current self-position of the moving body is the same as the self-position at a time point when the series of the past sensor data is acquired when the divergence degree between the series of current sensor data and the series of past sensor data specified by the searching is equal to or less than a predetermined value.

5. The storage medium according to claim 1, wherein
the estimating includes repeatedly calculating the divergence degree while shifting the detection region specified by the current sensor data in a width direction of the moving body by a designated amount with respect to the detection region specified by the past sensor data, and estimating the self-position of the moving body based on the smallest divergence degree among divergence degrees calculated.

6. The storage medium according to claim 1, wherein
the sensor detects a space located in a specific direction with respect to the moving body, and
the current sensor data and the past sensor data are acquired by the same sensor.

7. The storage medium according to claim 1 further storing
a moving control program including in the position estimation program, wherein
the moving control program causes the computer to perform
executing moving control based on the self-position of the moving body estimated and the past sensor data stored in the memory.

8. The storage medium according to claim 7, wherein
the moving control program causes the computer to further perform
storing the current sensor data when the self-position estimated is outside a range of the past sensor data stored in the memory.

9. A position estimation apparatus comprising:
a microprocessor; and
a memory connected to the microprocessor, wherein
the microprocessor is configured to perform:
acquiring sensor data acquired by a sensor configured to detect a situation around a moving body;
dividing a detection region specified by the sensor data for each type of detection target included in the sensor data to generate region information indicating a position of a divided region in the detection region;
storing past sensor data acquired by the sensor in the memory in association with the region information;
calculating a divergence degree between a position of a current divided region specified by the region information associated with current sensor data acquired by the sensor and a position of a past divided region specified by the region information associated with the past sensor data acquired by the sensor and stored in the memory; and
estimating a self-position of the moving body based on the divergence degree calculated, wherein
the estimating includes, when the divergence degree is equal to or less than a predetermined value, estimating that a current self-position of the moving body is the same as the self-position at a time point when the past sensor data has been acquired.
